(19) United States
(12) Patent Application Publication
(10) Pub. No.: US 2010/0083529 A1
(43) Pub. Date: Apr. 8, 2010

(54) Dryer/Cooler Process and System

(75) Inventor: David E. Shepherd, Munford, TN (US)

Correspondence Address: BEEM PATENT LAW FIRM, 53 W. JACKSON BLVD., SUITE 1352, CHICAGO, IL, 60604-3787, US

(73) Assignee: Shepherd Systems, Inc., Munford, TN (US)

(21) Appl. No.: 12/244,550

(22) Filed: Oct. 2, 2008

(51) Int. Cl. F26B 3/02; F26B 21/06

(52) U.S. Cl. 34/493; 34/72

(57) ABSTRACT

A process and system for drying and cooling products by which relatively low air flow is used such that a substantial amount of the heat added to the products during manufacturing is recaptured to dry the product. The products have starting temperature and moisture content conditions higher than ambient conditions, and the process and system comprise drying and cooling the product using ambient air with minimal additional heated air, if any. The product may move through various drying and cooling sections where air being counterflowed removes both heat and moisture from the product, heating that air and allowing it to further dry the product.

### BACKGROUND OF THE INVENTION

1. Field of the Invention

The present invention is directed to a process and system for drying and/or cooling products such as animal feed, including both pelleted and extruded products or any other granular product.

2. Description of the Related Art

When processing products such as animal feed, oftentimes the product undergoes a treatment in which significant additional heat and moisture is added to the product. This moisture and heat should be removed from the product by drying and cooling methods to enhance quality, shelf life and other factors.

In the past, separate dryers and coolers have been used to facilitate this process. Traditionally, product would be loaded into a dryer, consisting of a long belt or table, a burner would ignite and heat air to approximately 300 degrees Fahrenheit, and that heated air would be passed over the product to dry it out. Then, the product would be transferred to a separate cooler where additional fans would be used to pass cooled air over the product, thereby cooling it to the desired level. These systems require significant energy input in terms of the amount of fuel combusted or required to heat air for the dryer. Moreover, the rapid drying of the product using such hot air may run the risk of “shocking” the product, i.e., drying the outside while trapping moisture inside, which may result in poor product shelf life. Shocking may also result in a poor finished product because it may cause the outside of the product to crack or may cause the product to break up into smaller pieces.

In addition, these systems may require further power consumption to transport the material from the dryer to the cooler.

More recently, counterflow dryers and coolers have been implemented to incorporate both drying and cooling procedures into a single system in an attempt to reduce energy demands as compared to those of horizontal coolers. These coolers move the product to be dried and/or cooled in one direction while passing high volume air in an opposite direction. These dryer/coolers are more energy efficient than traditional horizontal dryers but may still leave room for further advancements in efficiency.

What is needed is a process and system for drying and cooling that overcomes the drawbacks described above and exhibits even greater energy efficiency.

### BRIEF SUMMARY OF THE INVENTION

In one aspect of the invention, a process for drying and cooling product having a starting temperature higher than ambient air temperature and a starting moisture content higher than a final moisture content, comprising: continuously feeding product in a first direction through a series of hopper sections including at least one drying section and at least one cooling section; moving air through product in a second direction that is generally opposite the first direction and recirculating at least a portion of the air through the product in at least one drying section. The air flow through the cooling section may be sufficiently low enough to cause the air temperature in the cooling section to be close to a product temperature in the drying section, possibly hotter. In addition, the process may comprise the step of adding heated make-up air to air passing through the product in at least one drying section to further dry the product. The air may move through at least one cooling section slowly enough so as to cause evaporative cooling of the product in the cooling section. Moreover, the air may be at generally ambient conditions as it enters the at least one cooling section, which may enable it to acquire more heat and moisture from the product throughout all of the process than if it were moving at an increased rate.

In another aspect of the invention, a process for drying and cooling product having a starting temperature higher than ambient air temperature and a starting moisture content higher than a final moisture content, comprising: loading a first set of product into a drying section; transferring at least a portion of the product into a cooling section; passing air at ambient temperature and humidity conditions through product in the cooling section to warm the air and cool the first set of product, wherein an air flow through the cooling section is sufficiently low enough to cause an air temperature in the cooling section to be close to, and possibly hotter than, a product temperature in the cooling section; loading a second set of product into the drying section; passing the warmed air through the second set of product to remove heat and moisture from the second set of product; transferring at least a portion of the second set of product into the cooling section and conveying at least a portion of the product in the cooling section out of the cooling section. The process may further comprise recirculating at least a portion of the warmed air through the drying section to further warm the air and dry the product.

In addition, the process may comprise preloading the product in an additional drying section above the other drying section before the product is loaded into the other drying section. Product may be generally continuously loaded into this section and systematically dumped into the next drying section. The process may additionally include passing that further warmed air through product when it is in the additional drying section to remove additional moisture from the first set of product and the second set of product. Moreover, the air flow through the additional drying section may be high enough so as to substantially fluidize product in the additional drying section.

In another aspect of the invention, a system for drying and cooling comprising a drying section, a cooling section, the cooling section having at least one aperture through which ambient air flows into the cooling section, a discharge section between the drying and cooling sections, the discharge section permitting air flow from the cooling section to the drying section, the drying section having an exhaust, and the exhaust operatively coupled to an opening above the cooling section. The system may further comprise an air heater operatively coupled to the opening or to a second opening in the cooling section in order to pass heated air into the system to enhance drying. In addition, one or more of the openings may be proximate the discharge section, preferably below the discharge section, so as to cause the recirculated and/or additional heated air to be passed through the product to enhance drying.

Additionally, the system may further comprise a second cooling section proximate the first cooling section to provide for additional cooling of the product to a desired temperature level and a second discharge section between the cooling sections, the section discharge section permitting air flow between the cooling sections. In addition, the second cooling section may have an opening for intaking ambient air.

These and other features and advantages are evident from the following description of the present invention, with reference to the accompanying drawings.

### BRIEF DESCRIPTION OF THE SEVERAL VIEWS OF THE DRAWINGS

FIG. 1 is a front view of one embodiment of a drying and cooling system for carrying out the inventive process, sectioned in some areas to show additional details of the system.

FIG. 2 is a side view of a portion of the system shown in FIG. 1.

FIG. 3 is a top view of the system shown in FIG. 1.

FIG. 4 is one embodiment of a discharge grid section with grid portions shown in a “product total clean out” configuration.

FIG. 5 is the discharge grid section of FIG. 4 with grid portions shown in one version of a “product dumping cycle” configuration.

FIG. 6 is the discharge grid section of FIG. 4 with grid portions shown in a closed position.

FIG. 7 is another embodiment of a discharge grid section.

FIG. 8 is yet another embodiment of a discharge grid section.

FIG. 9 is a rear view of a second embodiment of a portion of a drying and cooling system for carrying out the inventive process.

FIG. 10 is a section view through line 10-10 in FIG. 9.

FIG. 11 is one embodiment of a display screen for a control system used with the inventive system and process.

FIG. 12 is a screenshot of a recipe screen used with the inventive system and process.

FIG. 13 is a graphical representation of various product and air temperatures at various locations within one embodiment of the inventive system for multiple runs of the system.

FIG. 14 is a graphical representation of various product temperatures at various locations within one run of one embodiment of the inventive system.

### DETAILED DESCRIPTION

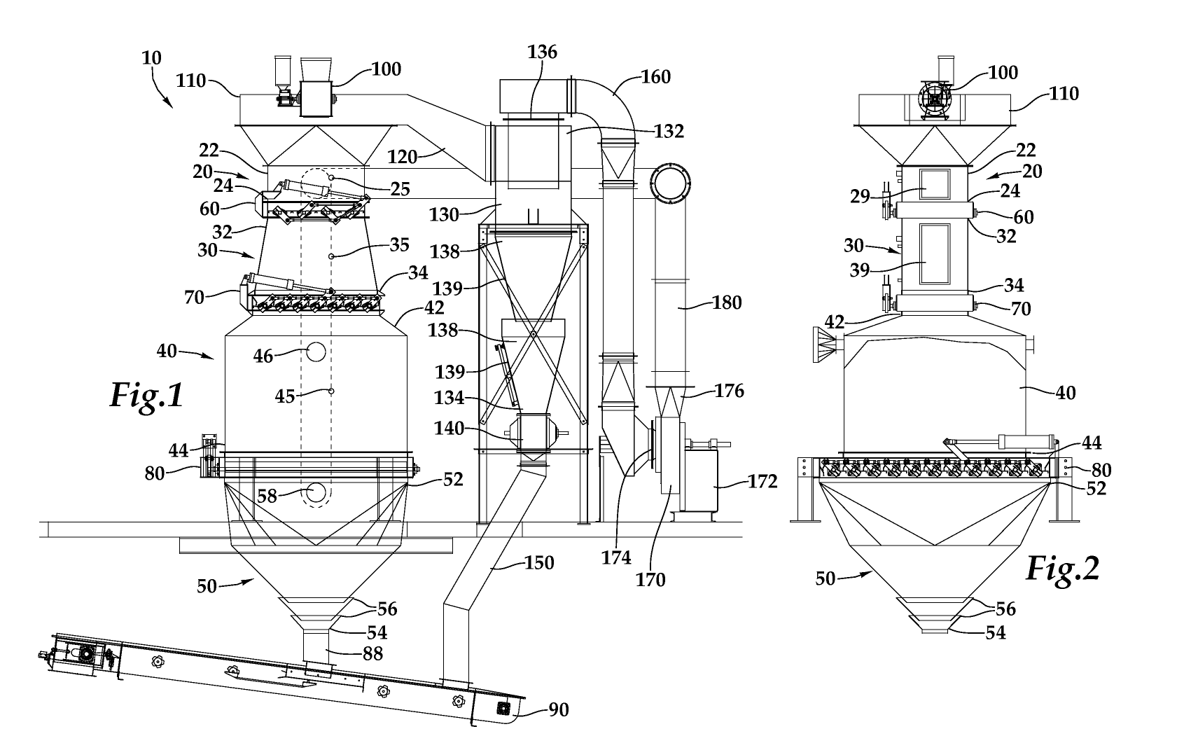

As seen in FIGS. 1-3, a process and system for drying and cooling hot products to ambient conditions or below using minimal air flow. The process may further facilitate drying through the use of additional heated air. System 10 and process take advantage of counter-flowing air and product to achieve significant energy savings, i.e., air travels in one direction and passes through product that is moving in another direction. As the air passes through the product it removes heat from the product, thereby cooling the product and warming the air. This warmed air is then passed through additional product, which it dries by virtue of the fact that warmer air can hold more moisture than cooler air.

The products to be dried may be pelleted or extruded, such as animal feed, for example. Typical pelleted products may have a starting temperature of between about 180 degrees Fahrenheit and about 190 degrees Fahrenheit, may have a starting moisture content of between about 15% and about 18% and may have a density between about 40 lb. per cubic foot and about 50 lb. per cubic foot. Typical extruded products may have a starting temperature between about 190 degrees Fahrenheit and about 205 degrees Fahrenheit, may have a moisture content of between about 19% and about 23% and may have a density between about 17 lb. per cubic foot and about 30 lb. per cubic foot. In addition to pelleted or extruded products, a product to be dried and/or cooled may be any hot granular product with moisture and heat in the product.

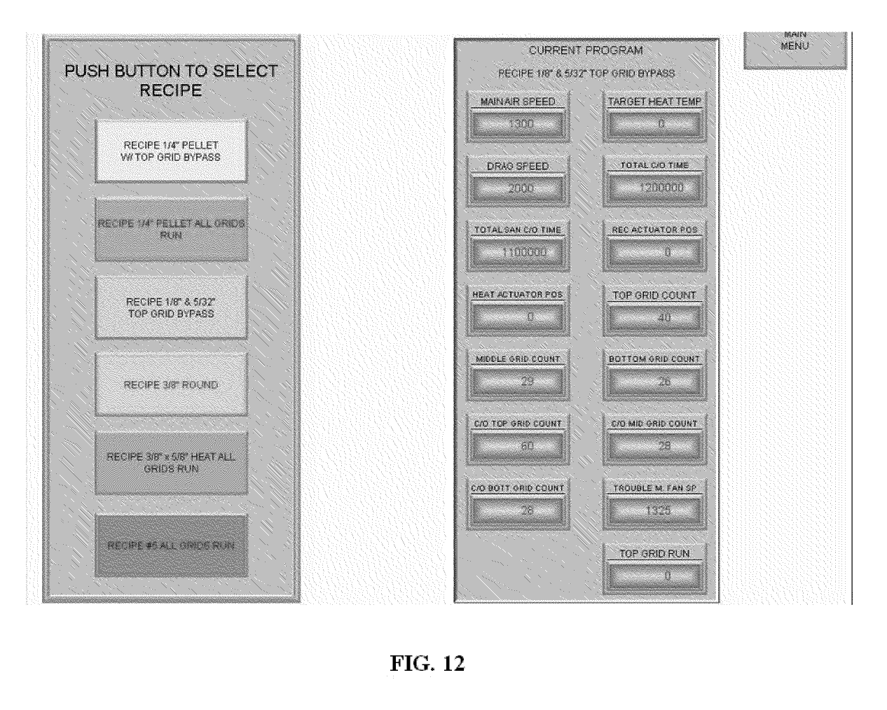

In contrast to other counterflow dryer/coolers, the process of the current invention counterintuitively uses low air flow to obtain significant energy savings. While air flow may technically be decreased towards 0 CFM, there may be practical limits to how low the flow should be. First, the air flow should be high enough to distribute the air through the product sufficiently in the system, to ensure thorough drying of all product. Second, without significant heated make-up air, which would be detrimental to the efficiency of the system, reducing air flow will not cause the air to be hotter than the initial temperature of the product. More conservatively, air flow may preferably not be reduced beyond a point at which the air temperature is within about 5 degrees of the initial product temperature. Preferably, air flow through system is between about that rate and about 1600 CFM, still more preferably between about that rate and about 1300 CFM, and in one embodiment between 800 and about 1000 CFM, although other air flow rates are within the scope of the invention. In addition, the rate of air flow may be adjusted based on the production rate of product moving through system. For example, the preferable ranges discussed above may be for a production rate of about 8 tons of product per hour. Moreover, the air flow rates may be adjusted based on the product to be dried and cooled, which rates may be pre-established through one or more product recipes, such as by selecting a recipe using the recipe screen shown in FIG. 12.

Ambient air may be drawn through system 10 as product is loaded into system. As ambient air passes through product, air temperature and humidity levels increase while product temperature and moisture content decrease. At least a portion of this warmer, moister air may be recirculated through the system and reintroduced below a drying section 30 such that the negative pressure in the system 10 causes the recirculated air to be drawn through product in the drying section 30. In addition, heated make-up air may also be added at this point.

Lower air velocities in cooling sections 40, 50 combined with larger volumes in cooling sections 40, 50 mean that more air is exposed to more product in these sections, and vice versa, for a longer time than are air and product in drying sections 20, 30. As such, intake air leaves first cooling section 40 significantly warmer than ambient. Since air's moisture holding capacity does not increase linearly with temperature, but actually increases more rapidly, this warmer air that leaves the first cooling section 40 is better able to remove moisture from the product, enhancing the ability of the process to dry product in the drying sections 20, 30.

This warm air then passes through product in drying sections 30, 20 where it acquires even additional heat and moisture. The process may then recirculate at least a portion of this air, as well as a limited amount of heated make-up air, through the product in the second drying section 30 to further enhance drying. Even though the air acquires more moisture as it dries, this is more than offset by the increases in water-holding capacity due to temperature increases. In this way, the process uses the energy in the product to heat the air that will be used to dry it while relying on the forced convection of the intake air through the product in the cooling sections 40, 50 to cool the product to its desired level. In fact, much like a warm breeze cools a wet surface to a temperature below that of the breeze, this process has been used to dry product to temperatures below the ambient air temperature by removing additional heat from the product.

In one example, for pelleted product having a starting temperature of about 180 degrees Fahrenheit and ambient air at about 90 degrees Fahrenheit, intake air moving at a rate of about 1300 CFM that is further additionally partially recirculated may cause exhaust air to exit at between about 160 degrees and about 170 degrees. Adding a small amount of heated make-up air may lead to exhaust air temperatures of between about 180 degrees and about 190 degrees, which may be more than sufficient to adequately dry product in drying sections 20, 30. However, while adding recirculated and/or heated make-up air to drying sections 20, 30 may enhance the efficiency of the system 10, increasing the overall air velocity to the levels seen in other counterflow dryer/coolers may actually cause air temperatures to plummet, driving efficiency down with it.

As the process continues, low air flow through cooling sections 40, 50 causes air temperatures in those zones to rise. The cyclical increases in air temperature and water holding capacity drive up the rate of evaporation of moisture in the product, further driving up air temperature. In this example, the low air flow may cause the air temperature in cooling section 40 to rise to about 50 degrees hotter than the temperature of product in drying section 30. By removing this excess heat from the product, two goals are met. First, the product in that cooling section 40 is able to be cooled to a desired temperature level. Second, that hot air is able to then pass through the product in drying section 30 to efficiently dry that product to an acceptable moisture content level. Depending on the selected air flow conditions, product may be cooled below ambient conditions, possibly as low as the wet bulb air temperature of the intake air.

As discussed below, multiple systems may be capable of carrying out this process. For example, system 10 may comprise a series of stacked drying and cooling sections. In the embodiment seen in FIGS. 1-3, system 10 comprises a first drying section 20 having a top 22 and a bottom 24, a second drying section 30 having a top 32 and a bottom 34, a first cooling section 40 having a top 42 and a bottom 44 and a second cooling section 50 having a top 52 and a bottom 54. In addition to cooling product, first cooling section 40 and second cooling section 50 may also serve to further dry product to desired moisture content conditions.

In one embodiment, first drying section 20 may comprise a generally rectangular or cylindrical portion from top 22 to bottom 24. First drying section 20 may be underneath a section of an exhaust plenum 110 that expands outwardly and upwardly from top 22. The expansion of plenum 110 may decrease air speed in plenum as air travels upwardly so as to prevent unwanted product removal from escaping system 10 through plenum 110. Second drying section 30 may comprise a tapered rectangular section that extends outwardly from 32 to bottom 34, but it may also have other configurations. Second drying section 30 may also have a height greater than a height of first drying section 20 so as to enable second drying section 30 to hold a greater amount of product than first drying section.

First cooling section 40 may be generally cylindrical or rectangular from top 42 to bottom 44. In one embodiment, first cooling section 40 may have a diameter of about 6 feet and a height of about 4½ feet. To avoid stacking of product in the center of bottom 44 of first cooling section 40, one or more dividers, separators or distributors may be installed inside cooling section 40 distribute the product more evenly along the bottom 44, enabling more consistent, more efficient cooling of product. Large volume may further allow a greater amount of product to be stored in first cooling section 40 at any given time, allowing for greater retention time and, therefore, better cooling of product. Second cooling section 50 may have a generally cylindrical portion or a portion that tapers slightly inwardly from top 52, followed by a generally conical portion. In the embodiment shown in FIG. 1, second cooling section 50 may have a total height of about 5 feet and conical portion may have a height of about 3 feet.

System 10 may also comprise a first discharge grid section 60 between bottom 24 of first drying section 20 and top 32 of second drying section 30. In addition, system 10 may have a second discharge grid section 70 between bottom 34 of second drying section 30 and top 42 of first cooling section 40. System 10 may further have a third discharge grid section 80 between bottom 44 of first cooling section 42 and top 52 of second cooling section 50.

Discharge grid sections 60, 70, 80 may prevent product from passing between various drying and/or cooling sections while still allowing airflow between sections and through product above each grid section. Discharge grid sections 60, 70, 80 may have surfaces perforated with a plurality of holes, for example, to accomplish this goal, although other forms of surfaces are acceptable. Discharge grid sections 60, 70, 80 may comprise rotatable grid portions, laterally sliding grid portions, trap doors or other types of adjustable separators.

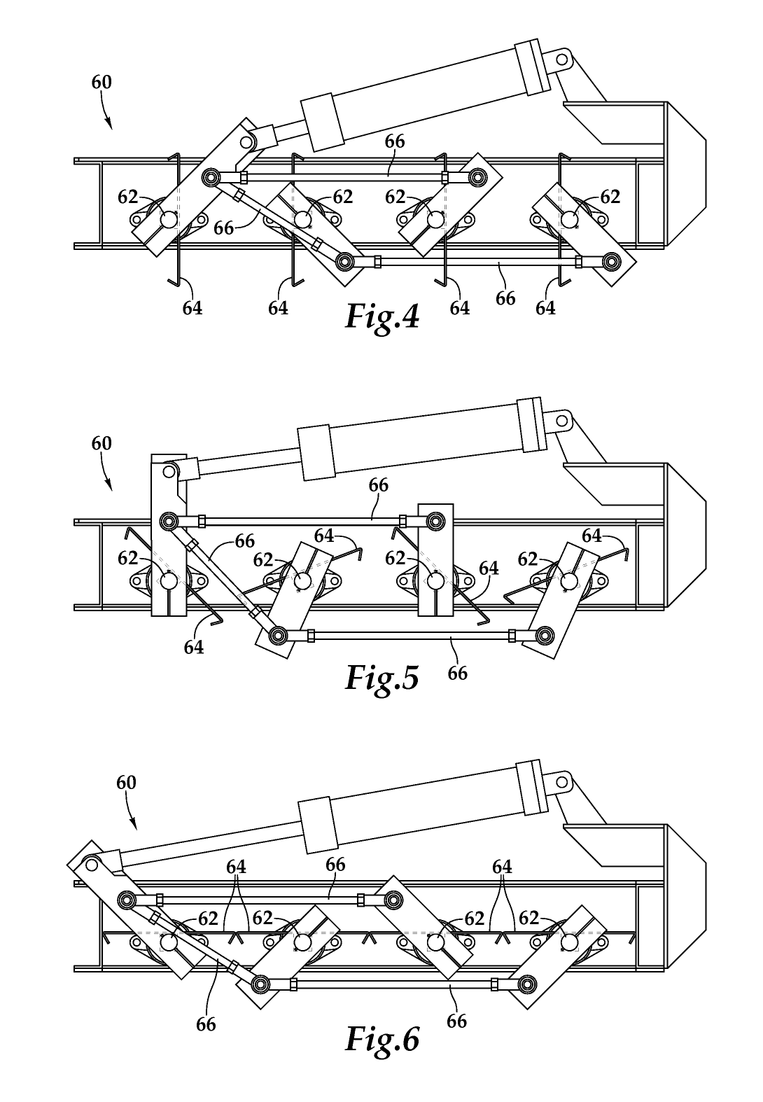

In the embodiment shown in FIGS. 4-6, first discharge section 60 may comprise a plurality of grid portions 64, each grid portion 64 preferably comprising a perforated metal surface such that substantially all of first discharge grid section 60 is perforated to allow for air flow through each grid portion 64. In addition, grid portions 64 may provide a clearance around their exterior to allow for generally unrestricted opening and closing of grid portions 64 and to provide additional paths for air flow. Perforations may be preferable in increasing air velocity through first discharge section 60, serving to agitate product, exposing a greater amount of product surface area to moving air to improve drying. In addition, system 10 may monitor air velocity of system 10 to maintain a desired velocity in first drying section 20 to properly fluidize product.

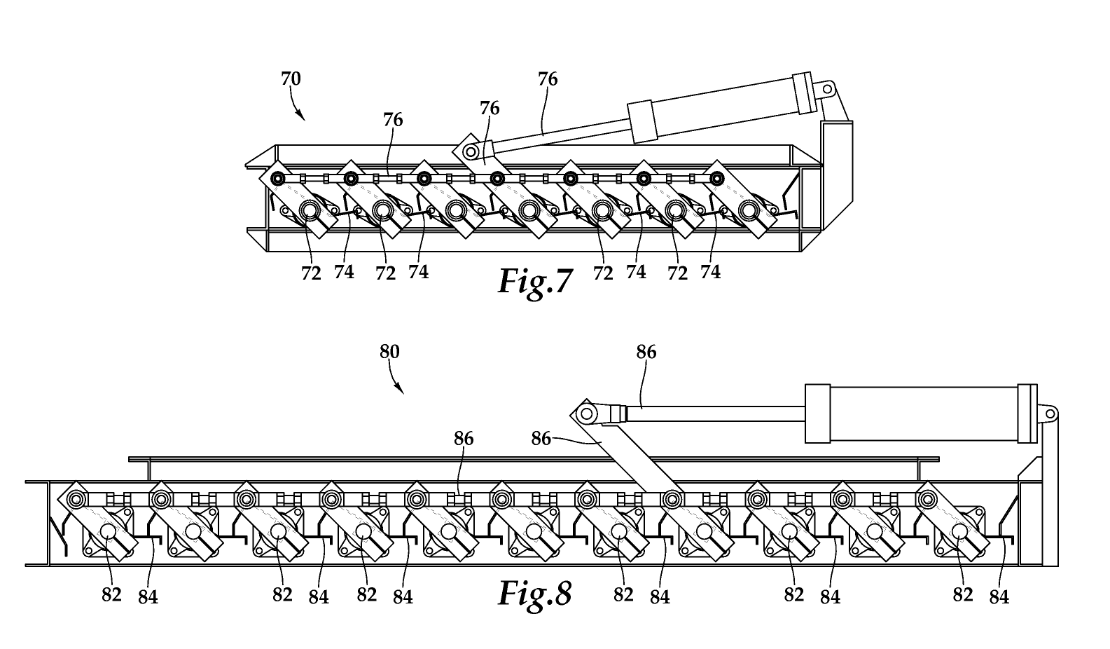

Turning to FIG. 7, second discharge section 70 may resemble first discharge grid section 60 in that it may comprise a plurality of interfacing grid portions 74. However, grid portions 74 of second discharge section 70 may have fewer perforations than grid portions 64. For example, each grid portion 74 may have fewer holes than each grid portion 64 or grid portions 74 may alternate between solid and perforated portions. Second discharge section 70 may be larger than first discharge section 60 such that, even with fewer perforations to allow for free-flow of air, air velocities through second discharge section 70 may be less than for first discharge section 60. As such, air passing through second discharge section 70 may circulate through product but may or may not further agitate product. Similar to first drying section 20, system 10 may monitor air velocity to maintain desired velocity in second drying section 30.

Third discharge section 80 may also comprise a plurality of grid portions 84. However, as air flowing through third discharge section 80 preferably cools product as opposed to primarily drying it, grid portions 84 may have even fewer, and preferably no, perforations. In the embodiment shown in FIG. 8, grid portions 84 may comprise solid trays. In this embodiment, air may flow through third discharge section 80 via openings resulting from clearance between grid portions 84 and perimeter of third discharge section 80 and/or between one grid portion 84 and another grid portion 84. In this manner, air flow may be more evenly distributed throughout product in first cooling section 40 to substantially uniformly cool product. In addition, as the area of openings in third discharge section 80 may be smaller than the area of openings in first discharge section 60, a substantially larger air flow velocity past third discharge section 80 as compared to past first discharge section 60 may be experienced.

Discharge grid sections 60, 70, 80 may have dynamic components to regulate flow of product between drying and cooling sections. Discharge grid sections 60, 70, 80 may comprise at least one rotatable shaft 62, 72, 82 operatively coupled to at least one grid portion 64, 74, 84, respectively. In the embodiments shown in FIGS. 4-8, discharge grid sections 60, 70, 80 comprise a plurality of rotatable shafts 62, 72, 82 operatively coupled to a plurality of grid portions 64, 74, 84 and, with respect to each discharge gird section 60, 70, 80, grid portions 64, 74, 84 may operatively interface with other grid portions 64, 74, 84 to regulate flow of product between various drying and/or cooling sections. Grid portions 64, 74, 84 may be centered over shafts 62, 72, 82 or may be off-center depending, e.g., on desired flow characteristics of product through discharge grid sections 60, 70, 80.

Grid portions 64, 74, 84 may be rotatable between a generally closed or horizontal position and a generally open, total clean out or vertical position. In addition, grid portions 64, 74, 84 may be adjustable to one or more desired angular positions to regulate a flow of product from one section to another in one or more product dumping cycles. Various angular positions may also be desirable because grid portions 64, 74, 84 may need to be opened to different degrees to dump product depending on air flow rate. For example, air moving at a faster velocity may generate a larger upward force on product, suspending product and necessitating a larger opening between grid portions 64, 74, 84 to transfer product from one section to another.

Moreover, grid portions 64, 74, 84 may be sized to create a clearance between grid portions 64, 74, 84 and walls of first discharge section 60, second discharge section 70 and third discharge section 80, respectively. Clearance may be between about 0 inches and about ¼ inch, preferably between about 0 inches and about ⅛ inch, and in one embodiment, about 1/16 inch.

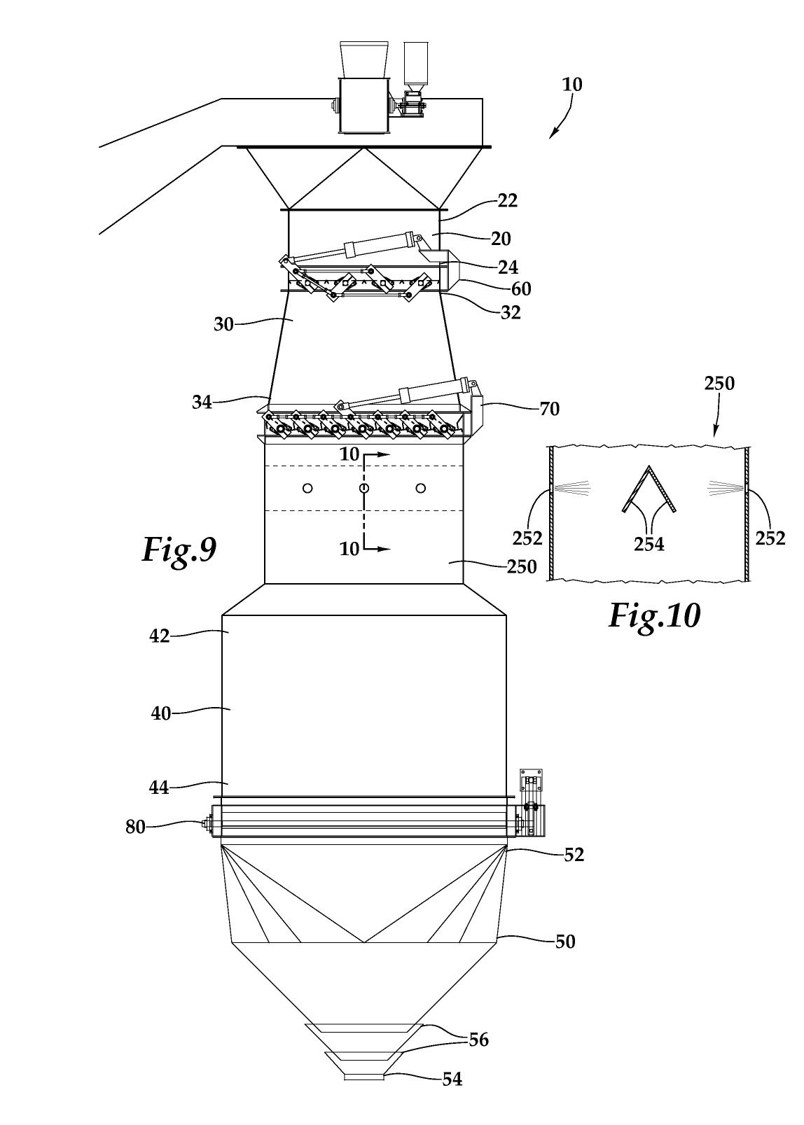

Turning to the embodiment shown in FIGS. 9-10, system 10 may further have an ingredient addition mechanism 250. Preferably, ingredient addition mechanism 250 is spaced between drying and cooling sections, for example, between top 42 of first cooling section 40 and second discharge section 70. In the embodiment shown in FIGS. 9 and 10, ingredient addition mechanism 250 may include one or more sprayers or nozzles 252 for adding fats or other liquids or coatings to product, however additional types of ingredient addition mechanisms are within the scope of the invention. In this embodiment, system 10 may further comprise a beveled surface or surfaces 254 angled outward from top to bottom to distribute product toward outer walls of system. Nozzles 252 may be aimed at beveled surfaces 254 to spray liquid and coat product as product travels past nozzles 252 along surface or surfaces 254.

In another embodiment, system 10 may comprise an insulated intermediate product conveyance 260 (not shown) and an insulated intermediate product return 270 (not shown). Intermediate product conveyance 260 may remove a selected amount of product from a drying or cooling section and convey it to another receptacle in which fats or other liquids or coatings may be added to product. The product may be agitated or otherwise mixed in the other receptacle to promote generally even distribution of the added material and then conveyed back into the same or a different drying or cooling section via intermediate product return 270 to continue the drying and/or cooling process.

By operatively connecting drying sections 20, 30, cooling sections 40, 50, discharge sections 60, 70, 80, 88 and/or ingredient addition mechanism 250 or intermediate product conveyance 260 and intermediate product return 270, the system 10 may perform both drying and cooling functions in a single unit. In addition to the significant energy savings that may be realized, this configuration may also result in a smaller, more compact footprint such that the system takes up less space than with separate dryers and coolers, which may be particularly beneficial when retrofitting an existing space with the new system 10. In addition, the operative connectability may retain most, if not generally all, of the product within the system 10 during drying and cooling, which may facilitate maintaining sanitary conditions for the product, which, as described above, may be a feed product, for which sanitary conditions are important.

System 10 may have a product intake such as first rotary airlock 100. Airlock 100 allows product to enter system 10 while minimizing airflow entering into system 10 through product intake, which may increase efficiency of system 10. Preferably, airlock 100 functions to keep system 10 operating in negative pressure to prevent airflow into system 10. As seen in the embodiment of FIG. 1, airlock 100 may be proximate top 22 of first drying section 20 so that hot, moist product may be introduced directly into first drying section 20. Locating airlock 100 proximate top 22 may allow product to be gravity-fed through system 10.

System 10 may further have an air intake such as apertures 56 proximate bottom 54 of second cooling section 50. Apertures 56 may be overlapping shingles, upwardly facing louvers or another type of perforated material, so as to allow air to enter system 10 while reducing or generally eliminating the amount of product escaping system 10.

In addition to airlock 100, system may further comprise an exhaust air plenum 110 and first ducting 120 such as exhaust air ducting proximate top 22 of first drying section 20. Plenum 110 and first ducting 120 convey air in from apertures 56, through system 10 and out of first drying section 20.

First ducting 120 may further convey air into a separator such as an inertial separator or cyclone 130 further operating under negative pressure. Cyclone 130 may have a top 132 and a bottom 134 and, as seen in FIG. 1, may be separated into one or more sections 138 generally vertically aligned with respect to one another and having sides 139.

Air and fines may be conveyed into top 132 of cyclone 130. A second rotary airlock 140 may be located proximate bottom 134 of cyclone 130 to keep cyclone 130 operating under negative pressure conditions so as to cause fines to drop to bottom 134, where they pass through second rotary airlock 140 to fines return 150, which may convey fines to a final or terminal product conveyance 90 for removal from system 10 and, preferably, for final processing or packaging with the rest of the dried and cooled product into a downstream system.

While fines may drop through cyclone 130, air may be conveyed to an opening 136 in cyclone 130 spaced from bottom 134. As shown in FIG. 1, opening 136 may be proximate top 132 of cyclone 130 and may operatively connect cyclone 130 with second ducting 160.

Second ducting 160 may operatively connect cyclone 130 with intake 174 of air handling fan 170. Air handling fan 170 may create a negative air pressure in ducting 160 from cyclone 130 to fan 170, thereby drawing air from system 10, through cyclone 130 and second ducting 160 and into intake 174. Fan 170 may further have an output 176 through which air may be conveyed under positive pressure away from second ducting 160 and into third ducting 180. In addition, fan 170 may have a variable frequency drive 172 which may be controlled by control system 280 to regulate a rate of air flow through fan 170 and, therefore, through system 10.

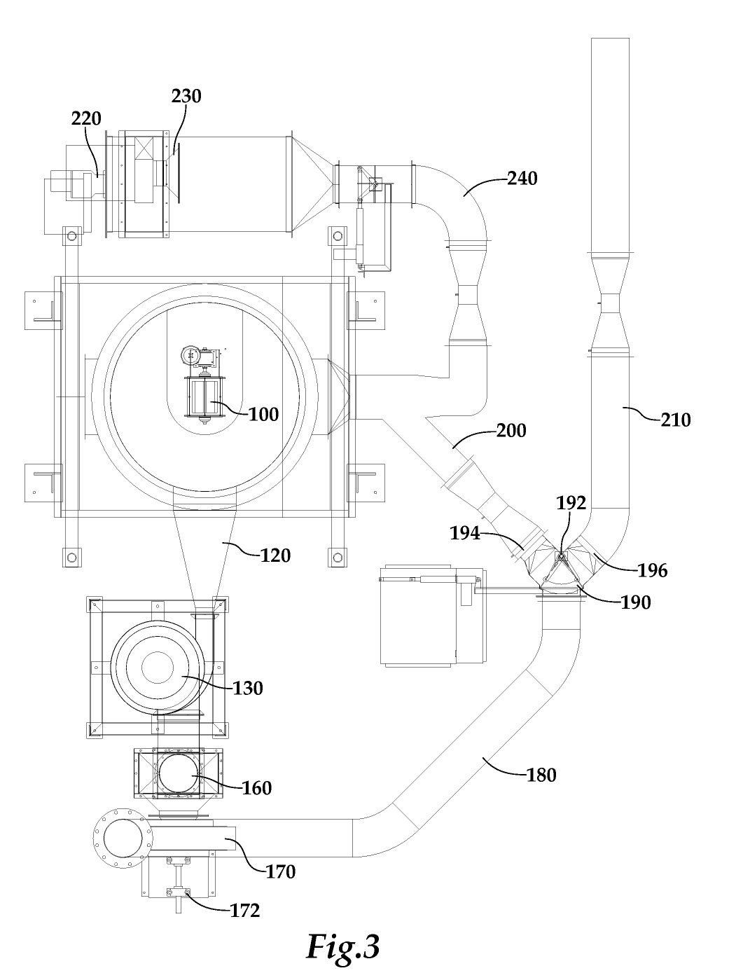

Turning to FIG. 3, third ducting 180 may convey air from fan 170 to a recirculation damper valve 190. Damper or diverter valve 190 may have an actuator 192 to control or distribute air flow through one or more openings 194, 196. First opening 194 may operationally engage fourth ducting 200, while second opening 196 may operationally engage fifth ducting 210.

Fourth ducting 200 may be recirculation ducting, conveying at least a portion of air exiting first drying section 20 back into system 10. Between about 20% and about 80% of air may be recirculated, preferably between about 30% and about 70%, and in one embodiment about 50%. In this embodiment, fan 170 should be capable of moving at least about 200% of a rate of air intake. Fan 170 is preferably designed to handle requirements from intake air, recirculated air and/or any heated make-up air. For example, in one embodiment, for input air moving at about 1600 CFM, fan 170 should be capable of moving at least about 3200 CFM. However, the addition of heated-make up air may cause a user to reduce the level of intake air.

Recirculated air may be significantly warmer than ambient air, so it may be particularly well-suited to be reintroduced into drying section 30. However, in the embodiment shown in FIGS. 1-3, fourth ducting 200 conveys recirculated air to opening 46 proximate top 42 of first cooling section 40, under second discharge section 70. In this way, recirculated air may pass through product at second discharge section 70, which may dry the product more thoroughly than if air entered second drying section 30 directly at a point at or above a product level in the second drying section 30. Recirculated air may also increase air velocity flowing through product, providing an additional mechanism by which air flow velocities may be adjusted in addition to intaking more ambient air or adding heated make-up air.

In another embodiment, fourth ducting 200 may split to convey air to both second drying section 30 and first cooling section 40, for example through opening 46 proximate top 42 of first cooling section 40 and through a second opening 58 proximate top 52 of second cooling section 50, below third discharge section 80, to pass through second discharge section 70 and third discharge section 80, respectively.

Fifth ducting 210 may comprise exhaust air ducting to convey non-recirculated exhaust air out of system 10.

Turning back to FIG. 3, system 10 may further comprise a heated air burner 220 operatively connected to heated air fan 230. Heated air burner 220 may heat additional air to add to system 10 to aid in drying product. Heated air fan 230 may convey air through sixth ducting 240 in a manner similar to the conveyance of recirculated air through fourth ducting 200. For example, sixth ducting 240 may be operationally connected to opening 46 or second opening 58. Sixth ducting 240 may alternatively be operatively connected to fourth ducting 200, with air being conveyed through both sets of ducting to opening 46 and/or second opening 58. Preferably, recirculated air in fourth ducting 200 and heated make-up air in sixth ducting 240 enter through the same opening to better mix the air and reduce air temperature entering this area. This may both enhance sanitation and decrease the risk of a fire hazard in system 10.

System 10 may further comprise a control system 280 to regulate, optimize or otherwise control air flow and/or temperature in various drying and cooling sections. Air conditions may be monitored and regulated by one or more of: sensors 282 to detect temperature conditions inside drying and/or cooling sections, sensors 284 to detect humidity conditions inside drying and/or cooling sections (including grains of water, dew point, relative humidity, etc.) and controls 286 on valves to regulate recirculated and/or additional heated air.

Humidity or moisture regulation may be important because overly-moist product may clump together or may cause condensation in product packaging, which may cause product to spoil more quickly. Conversely, it may be possible to dry product beyond a desired level, which is not desirable due to shrinkage of the product. Moreover, removing too much moisture may make system less cost efficient since additional energy may be required to accomplish the additional drying and because it results in loss of product being manufactured.

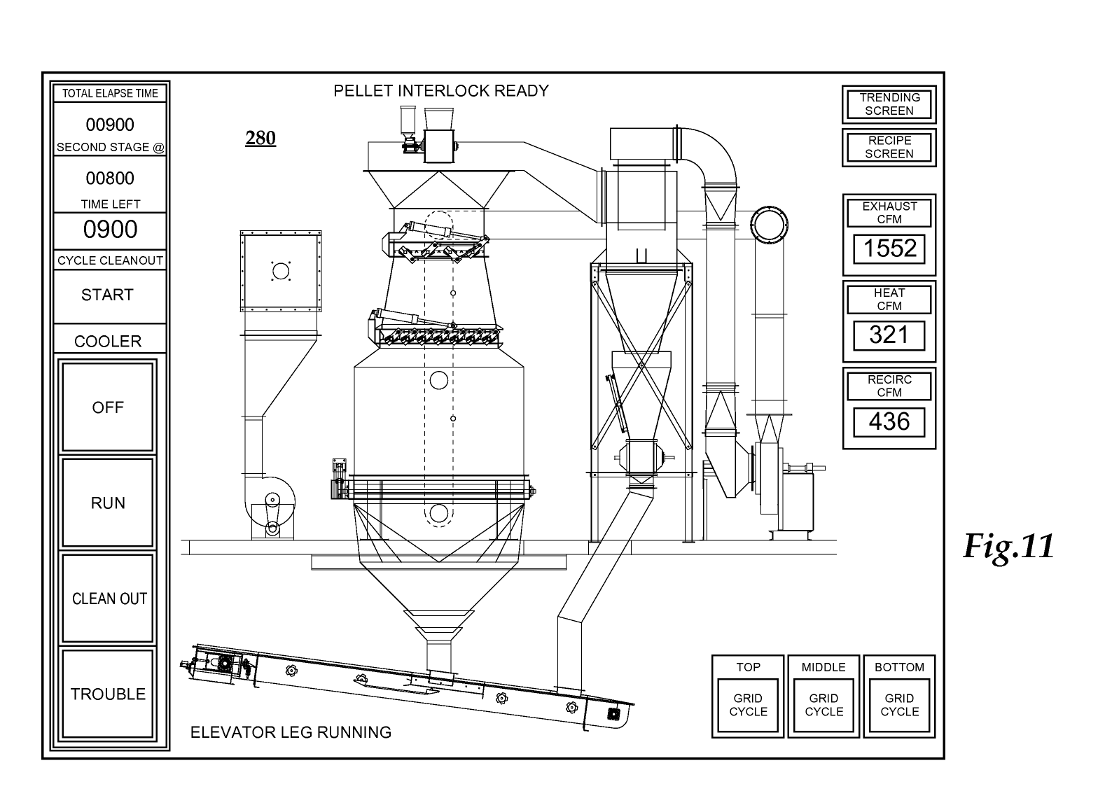

Control system 280 may alleviate these problems by sensing moisture content of product in one or more drying and/or cooling sections and/or by sensing relative humidity of air in those sections, for example by measuring grains of moisture per pound of air. As control system 280 monitors one or more of these values, it may control intake, recirculation and/or heated make-up air-flow to obtain desired ranges. For example, since recirculated air may have a higher relative humidity than ambient air, if system 10 or process require more or less humid air or a greater or lower air velocity in drying sections 20, 30, control system 280 may adjust actuator 192 to regulate damper valve 190, thereby allowing more or less recirculated air into system 10. Control system 280 may be managed through a display screen such as the one shown in FIG. 11. Display screen may be directly connected to system 10 to allow local access of system 10 and/or system 10 may have remote access to enable a user at an off-site location to view system data, review the process and/or control system 10.

Control system 280 may further regulate air flow, for example, to control temperature conditions of air inside drying sections 20, 30, flow rate throughout system 10 and/or the amount of recirculated air through fourth ducting 200. Higher velocity air may be necessary in order to fluidize product during drying, so as to avoid clumping. Conversely, in cooling sections 40, 50, a slower rate of air flow may result in air reaching a higher temperature in cooling sections 40, 50 and increase the moisture-carrying capability, thereby improving drying in drying sections 20, 30. In addition, air flow may be regulated so as to avoid “shocking” the product, or passing too much cooled air over a still hot, still moist product. Shocking may cool the outside of the product but trap moisture inside without adequately drying the product. As such, system 10 may ensure that air used in the drying process is warm enough to avoid shocking.

Preferably, control system 280 operates by inputting a “recipe” for a desired product having generally known starting temperature and moisture conditions and desired final temperature and moisture conditions. Control system 280 may initiate air flow through system 10 then begin adding product to system 10. As product continues to be added to system 10 or as product makes its way through system 10, control system 280 may adjust air flow to achieve the desired results. For example, control system 280 may adjust the variable frequency drive 172 of fan 170 from an idle speed of about 20% to a running speed of about 85% during the process so as to increase the amount of air through system 10.

Control system 280 may also have manual overrides to customize or control system. For example, control system may allow a user to override level switches and manually control discharge grid portions 64, 74, 84. However, these overrides are preferably used for maintenance purposes such that control system 280 generally automates process to increase efficiency,

System 10 may additionally be insulated generally throughout to retain heat within system 10, for example, by placing at least one layer of insulation 290 between an inner wall and an outer wall of various sections of system, including, e.g., first drying section 20, second drying section 30, and first cooling section 40. Second cooling section 50 may also be insulated, but, as product may be substantially cooled, may not be insulated.

Alternatively or in addition, insulation 290 may be placed around outside walls of one or more of the sections listed above and/or around one or more of first ducting 120, second ducting 160, third ducting 180, fourth ducting 200, fifth ducting 210 and/or sixth ducting 240. In addition to retaining heat in system 10, insulation 290 may prevent condensation on interior of system 10 that may be caused by the temperature difference between ambient air outside system 10 and the heated air inside system 10.

The process described above is set forth below in greater detail as it pertains to the system 10 just described.

Product having a temperature and moisture content higher than ambient air temperature and relative humidity may enter system 10 through rotary airlock 100, continuing to enter first drying section 20 until level switch 25 is activated. Grid portions 64 of first discharge section 60 may be generally horizontal or closed to prevent product from leaving first cooling section 20 until level switch 25 is activated or predetermined temperature and/or humidity conditions are achieved.

While first drying section 20 fills with product, fan 170 may already be running to draw ambient air through apertures 56 and through system 10 where air comes in contact with product. A building employing system 10 or process may heat its air, e.g., during the winter. In these cases, ambient air may refer to this heated air and not the colder outside air, such that it may be necessary to elevate air temperature a smaller amount to effectuate drying.

Variable frequency drive 172 may be adjusted, additional air may be recirculated and/or heated make-up air may be employed to adjust air flow to substantially fluidize product over first discharge section 60, i.e., upward force on product caused by moving air may create separation between product and grid portions 64 and force of air may further separate product particles increasing the surface area of product exposed to moving air, in turn increasing the rate and/or effectiveness of drying. First drying section 20 and/or section drying section 30 may have one or more windows 29, 39 to permit a user to view inside first drying section 20 and/or section drying section 30 to determine if product is being sufficiently fluidized or to determine if adjustments in air flow may be required. Fluidizing may prevent product from lumping or adhering together until its moisture content is lowered to a level that will prevent lumping.

Air flow and velocity in drying sections 20, 30 may be controlled by the size of each section, the ability to recirculate at least a portion of the airflow through each section and adding additional, heated air to one or more of the sections. Second drying section 30 and/or first drying section 20 may be sized to have a diameter or other cross-sectional area generally smaller than a diameter or other cross-sectional area of first cooling section 40. Smaller diameter may increase a linear rate of air flow in drying sections 20, 30, while maintaining a generally constant volumetric airflow throughout all of system 10, facilitating fluidization of product in one or more drying sections. In addition, first cooling section 40 may taper from bottom 44 to top 42 to increase the velocity of air moving into second drying section 30, and second drying section 30 may likewise taper from bottom 34 to top 32 to increase further the velocity of air moving into first drying section 20. Moreover, recirculated and/or additional heated air may be incorporated with air traveling upwards from below product in first drying section 20, increasing the air temperature, thereby increasing its water-holding capacity and leading to increased product drying.

When first level switch 25 is activated, first discharge section 60 may open to convey product into second drying section 30. First discharge section 60 may then close as new product is added through first airlock 100 into first drying section 20.

Like first drying section 20, air may travel through second drying section 30 at a linear velocity high enough to generally agitate product as needed to prevent it from lumping together, although this velocity may be less than air velocity in first drying section 20. By the time product reaches second drying section 30, enough moisture may have been removed that air velocity in second drying section 30 may not need be as high as in first drying section 20. Recirculated or additional heated air may be incorporated below product in second drying section 30, for example by adding in recirculated and/or heated make-up air under second discharge section 70, increasing the air temperature, thereby increasing the air's water-holding capacity and leading to increased product drying.

Some processes have a need to add fat or another liquid or coating to a product after it is dried but before it has been cooled. Also as with first drying section 20, a level switch 35 may open grid portions 74 of second discharge section 70 when tripped, releasing at least a portion of product into first cooling section 40, but product may also be conveyed past ingredient addition mechanism 250 or onto intermediate product conveyance 260 to be mixed with coating and then returned to system 10 in first cooling section 40.

Product may be retained in first cooling section 40 longer than in other sections of system 10 to allow it to cool down sufficiently. As such, first cooling section 40 may be sized larger than drying sections 20, 30 and may be also be larger than second cooling section 50, although second cooling section 50 may also be larger than drying sections 20, 30. Larger size of cooling sections 40, 50 also means that air velocities and flow in these sections may be significantly less than in either of the drying sections 20, 30. This may be heightened by the fact that recirculated and/or heated make-up air may both preferably be added above these sections, further increasing air velocities and flow in the drying sections. When level switch is activated, grid portions 84 of third discharge section 80 rotate open to discharge at least a portion of product into second cooling section 50.

As it is discharged, product will fill second cooling section 50 where it will be further cooled by the motion of ambient air being drawn into system 10 through apertures 56 and through product. Bottom 54 of second cooling section 50 may be operatively coupled to a fourth discharge section 88. Fourth discharge section 88 may open intermittently, e.g., when triggered by a level switch, to convey at least some of product onto final conveyance for final processing and packaging. Alternatively or in addition, second cooling section 50 may taper towards bottom 54 and fourth discharge section 88 may operationally be left at least partially open. The combination of the shape of second cooling section and fourth discharge section 88 may create a bottle-neck for product so that product may flow generally continuously, if slowly, through fourth discharge section 88 and onto final conveyance 90.

While product may move through system 10 from dryer sections 20, 30 through cooler sections 40, 50, air generally flows in an opposite direction. System 10 may take advantage of thermodynamic properties of air to facilitate drying and cooling and to make system 10 substantially more energy efficient than prior art dryers and coolers.

Fan 170 operates to create negative pressure in system 10 such that air, preferably at ambient temperature and relative humidity conditions, enters system 10 through apertures 65 and is drawn upward through system 10. As air passes through product in first cooling section 40 and second cooling section 50, heat is removed from the product, e.g., via convection and evaporation, cooling the product and increasing the air temperature. When the air increases in temperature, it similarly increases in its water-holding capacity. While it may be intuitive to increase air flow to increase the amount of heat transfer, a low velocity air flow has shown superior results because the resulting air temperature increases allow for higher moisture removal. For example, while other counterflow dryer/coolers claim an efficiency of 2500 kJ per kg of evaporated water, or about 1075 Btu per pound, through experimental testing, the present process using low air flow has been found to require about 250 Btu per pound of water, i.e., it is more than 4 times more efficient than other counterflow dryer/coolers.

As this warm air moves upwards, it comes in contact with and passes through the warmer, moister product in the first and second drying sections 20, 30. The air may also be funneled into these smaller sections, increasing its velocity, which may agitate the product and increase the surface area of the product to which it is exposed. Due to its increased temperature and corresponding increase in water-holding capacity, this hot moving air may absorb significantly more moisture from the product than if the air was at ambient conditions, decreasing drying time and increasing efficiency of the process.

As the air exits first drying section 20 and is conveyed through first ducting 120, it is significantly warmer than ambient air and may be only slightly cooler than a starting product temperature. At least a portion of this air may be conveyed through first ducting 120, cyclone 130, second ducting 160, air handling fan 170, third ducting 180, recirculation damper valve 190 and fourth ducting 200 to opening 46 in first cooling section 40 where it is reintroduced into the drying process.

The following examples are provided to further demonstrate the process and illustrate several of its benefits over the prior art.

### EXAMPLE 1

### Conventional Horizontal Dryer/Coolers for Pelleted Product

A product such as animal feed having a starting moisture content of about 11% may be steam conditioned and pelleted to form a product having a moisture content of about 17% (or about 16.96%). Steam may be used both as a lubricant and a bonding agent. For a process in which about 8 tons of product per hour is pelleted, dried and cooled, about 1,150,000 BTU/hr of energy are added to the product during the pelleting process through both steam conditioning and, to a substantially smaller degree, through friction.

In order to dry the product to a final, predetermined, moisture content of about 9%, conventional dryer/coolers generally operate by heating air to about 300° F. using a burner or other means and then using a large fan to circulate this heated air over the product. For a pelleted product moving through these dryers at a rate of about 8 tons/hour, these prior art dryers may typically require adding an additional about 5,000,000 BTU/hr of energy to heat the air adequately. In total, to pelletize and dry the product requires adding about 6.15 million BTU/hr.

Fans move the heated air at approximately 16,000 CFM to dry the product. In addition, these dryer/coolers typically require about three different fans: a dryer fan, a cooler fan and a burner fan. In order to move air at the rates required for these systems, these fans require a significant amount of horsepower. For example, a dryer fan may require a 75 horsepower motor, a cooler fan may also require a 75 horsepower motor, and a burner fan may require a 40 horsepower motor, for a total power requirement of 190 horsepower.

### EXAMPLE 2

### Inventive Dryer/Cooler System and Process for a Pelleted Product

As with conventional systems, the system and process described above may add about 1,150,000 BTU/hr to the product during the pelleting process through steam conditioning.

To reduce the pelleted product from about 17% to a final moisture content of about 9% requires removing about 1,280 lbs water per hour (8% difference from a starting weight of 16,000 lbs of product per hour times 8 tons/hr). The latent heat of evaporation for water at a boiling point of 212° F. is about 970.3 BTU/lb water. Therefore, this removal would require about 1,280×970.3, or about 1,241,984 BTU/hour. By taking advantage of the heat added to the product during the pelleting process, this system and process may require about 1,241,984−1,100,00=141,984 BTU/hour or about 142,000 BTU/hour be added to the system. By another calculation, the 2% difference from the 11% starting moisture and the 9% final moisture may require about 310,496 BTU/hour of energy (0.02*16,000 pounds/hour*970.3 BTU/hour). Even assuming the more conservative of these two estimates, the present system and method may require at least about 4,689,504 BTU/hour less than conventional dryer/coolers, or at least about a 94% reduction in energy required to dry a pelleted product.

In addition as compared to the conventional system's air flow of about 16,000 CFM, fan 170 may move air through system 10 at about 1,600 CFM, or about a 90% reduction in airflow. By combining the dryer and cooler components, and as a result of this reduced airflow, a substantially smaller dryer/cooler fan may be used. For example, a 30 horsepower fan may be adequate. Additionally, this low air flow means the air is in contact with product for a greater length of time, enabling it to acquire a greater amount of heat and moisture from the product, thereby enhancing the cooling effects of system 10.

Moreover, while the process and system may be able to dry product adequately without the addition of external heated air, a significantly smaller burner may be used to provide additional heated air if desired. This burner may be useful, e.g., when ambient air conditions are significantly colder, as during winter months. As a result, the smaller burner fan may only require about 2 horsepower. In sum, the system and process may require only about 32 horsepower to drive its fans, as compared to 190 horsepower for conventional systems, resulting in savings of about 158 horsepower, or about 83%.

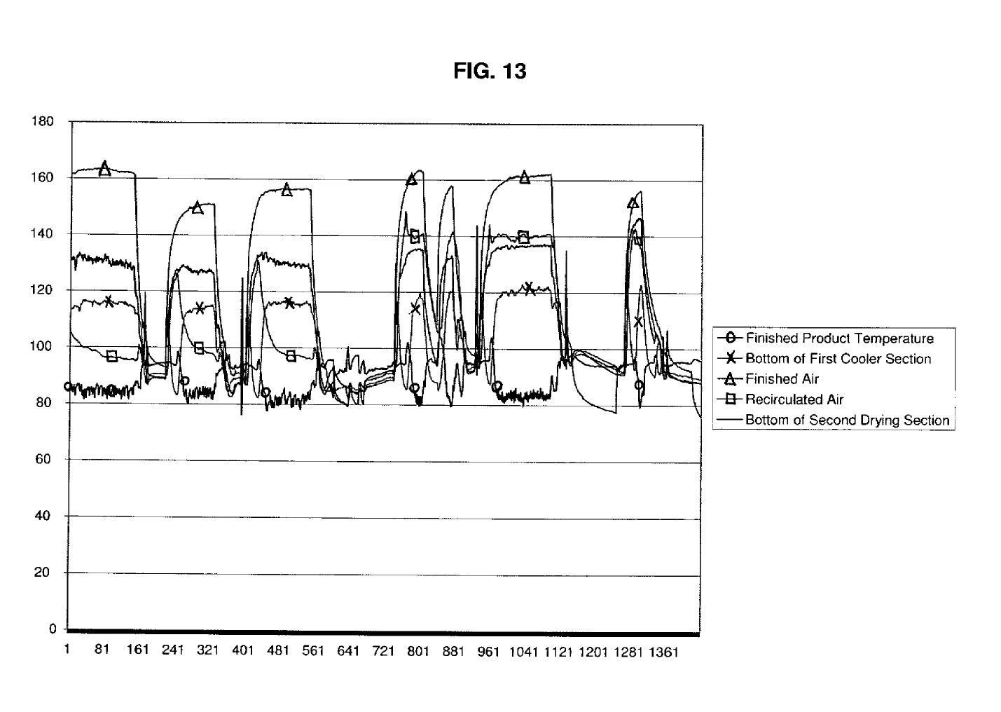

FIG. 13 shows air and product temperature curves at various locations within one embodiment of system 10 for multiple runs of the process. As can be seen in this figure, air temperatures generally increase substantially as air moves upward through system, with air at the bottom of the first cooler section 40 generally between about 115 and about 120 degrees Fahrenheit, air at the bottom of the second drying section 30 generally between 125 and 135 degrees Fahrenheit and ending with a final air temperature between about 150 and about 165 degrees Fahrenheit. In addition, product may end up with a finished temperature of between about 80 and about 90 degrees Fahrenheit, or about 30 to 35 degrees cooler than the air in the bottom of the first cooler section 40.

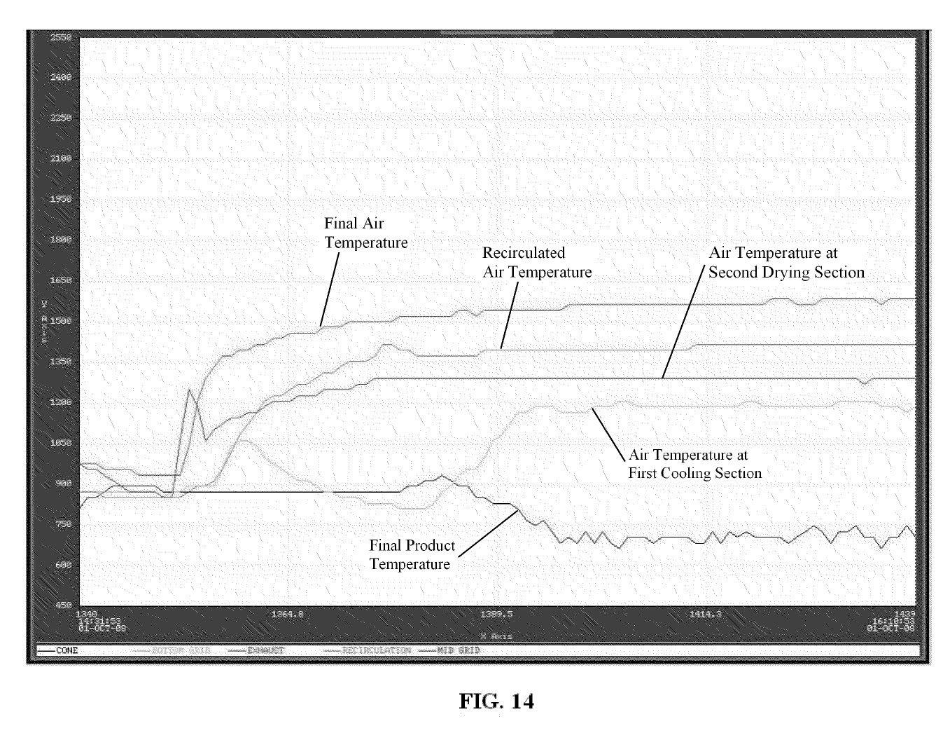

FIG. 14 shows product temperature curves for one run of one embodiment of system 10. As seen in the figure, as the process progresses, air temperatures increase steadily as product makes its way through the system and reach generally elevated steady-state conditions fairly rapidly. When product makes it to second cooling section 50, air temperatures in first cooling section 40 may drop slightly while product or air temperature in second cooling section 50 may rise slightly. However, process 10 may quickly compensate to cause a significant, substantial drop in final product temperature and a corresponding rise in air temperature in the cooling section. As seen in this figure, the gap between air and product temperatures may be between about 40 and about 50 degrees Fahrenheit, the difference between final product temperature and final air temperature may be between about 90 and 100 degrees or more Fahrenheit, and the final product may be cooled to between about 60 degrees and about 75 degrees Fahrenheit, which may be at or cooler than ambient air temperature.

### EXAMPLE 3

### Conventional Horizontal Dryer/Coolers for Extruded Product

As with pelleted product, extruded products may have an initial moisture content of about 11 %. In this case, the extrusion process may result in a product having a moisture content of about 21%, which results in about 1,410,533 BTU/hr being added to the product. This product may enter the process or system 10 at a starting temperature of about 200° F.

Due to the consistency of the extruded product and the need to keep it moving during drying so as to avoid product clumping, conventional systems may use at least about 10,000,000 BTU/hr to dry the product. In addition, to keep the product moving and substantially fluidized, larger, more powerful fans may be required than those used for pelleted products. For example, a conventional system may employ two 100 horsepower dryer fans, a separate 75 horsepower cooler fan, and two 50 horsepower burner fans, for a total requirement of 375 horsepower.

### EXAMPLE 4

### Inventive Dryer/Cooler System and Process for an Extruded Product

In contrast to conventional systems, which may require both separate dryer and cooler systems and separate overall systems for drying and cooling pelleted versus extruded product, the inventive dryer/cooler system may be used to both dry and cool both pelleted and extruded products.

Starting with a product having a moisture content of about 21% and drying it to a content of about 9% requires removing about 12% of the product's weight, which translates into about 1920 lbs. water per hour. Using the same latent heat of water used above, i.e. 970.3 BTU/lb water, means about 1,862,976 BTU/hr of energy would be required, or about 1,862,976−1,410,533=452,443 BTU/hr may need to be added to the system or process. By another calculation, the 2% difference from the 11% starting moisture and the 9% final moisture may require about 310,496 BTU/hour of energy (0.02*16,000 pounds/hour*970.3 BTU/hour). Even assuming the more conservative of these two estimates, the present system and method may require at least about 8,137,024 BTU/hour less than conventional dryer/coolers, or at least about an 81% reduction in energy required to dry an extruded product.

In addition, the same fans used in example 2 may be employed for drying an extruded product. As such, the dryer/cooler process and system in this example may require about 32 total horsepower, i.e., about 343 horsepower or about 91% less than with conventional systems.

### EXAMPLE 5

### Inventive System and Process for Cooling Only

For products that do not require substantial drying, system 10 may further be employed as just a cooler. Typical coolers in the industry may use about 500 CFM of air per ton of product per hour. Without the need to first dry product, a cooler system for pelleted product may be able to process about 60 tons/hr of product, resulting in about 30,000 CFM of air required for cooling. In addition, these conventional coolers may retain product for about 8 to 10 minutes in their primary cooling section(s).

In contrast, system 10 and process may take advantage of counter flow coolers such as first cooling section 40 and second cooling section 50 to cool and dry product using as little as about 150 CFM of air per ton of product per hour. For the same 60 tons/hr, this results in about 9000 CFM of air or about 70% less than the requirement for conventional coolers.

In this example, product may be retained in first cooling section 40 for about 10 to 12 minutes and second cooling section 50 for about 5 minutes, for a total time of between about 15 and about 17 minutes. While retention time may be higher than for conventional systems, cooling sections 40, 50 may be larger than in conventional systems so that product may be processed at about the same rate, e.g., about 8 tons per hour.

### EXAMPLE 6

### Effects of Raising Temperature on Drying

System 10 and process dry product by increasing air temperature from ambient conditions by capturing a substantial amount of the energy that was added to the product during its pre-drying processing. In this example, about 1600 CFM of air starting at ambient conditions may flow through system 10. Estimating the density of air at about 0.075 lb/cubic foot means that about 1600×0.075 or about 120 lb./minute of air flow through system 10.

The following table shows estimates for the weight of water, in pounds, that one pound of air may hold at a given air temperature and relative humidity:

| AIR | | | | | | | | |
|---|---|---|---|---|---|---|---|---|
| TEMP. | RELATIVE HUMIDITY | | | | | | | |
| (° F.) | 100% | 75% | 70% | 60% | 50% | 40% | 30% | 20% |
| 210 | 15.69200 | 1.61059 | 1.35 | 0.886 | 0.57630 | 0.38900 | 0.25230 | 0.14820 |
| 200 | 2.27189 | 0.89063 | 0.789 | 0.573 | 0.40191 | 0.28470 | 0.19160 | 0.11590 |
| 190 | 1.08759 | 0.56758 | 0.516 | 0.395 | 0.29013 | 0.21230 | 0.14670 | 0.09070 |
| 180 | 0.65164 | 0.38729 | 0.357 | 0.283 | 0.21381 | 0.16000 | 0.11280 | 0.07090 |
| 170 | 0.42907 | 0.27447 | 0.255 | 0.207 | 0.15951 | 0.12140 | 0.08680 | 0.05530 |
| 160 | 0.29675 | 0.19884 | 0.186 | 0.153 | 0.11980 | 0.09230 | 0.06670 | 0.04300 |
| 150 | 0.21101 | 0.14589 | 0.137 | 0.114 | 0.09020 | 0.07010 | 0.05120 | 0.03320 |
| 140 | 0.15243 | 0.10772 | 0.102 | 0.085 | 0.06789 | 0.05300 | 0.03900 | 0.02550 |
| 130 | 0.11100 | 0.07970 | 0.076 | 0.064 | 0.05096 | 0.04000 | 0.02960 | 0.01940 |
| 120 | 0.08108 | 0.05889 | 0.056 | 0.047 | 0.03806 | 0.03000 | 0.02230 | 0.01470 |
| 110 | 0.05916 | 0.04334 | 0.0413 | 0.035 | 0.02824 | 0.02200 | 0.01660 | 0.01100 |
| 100 | 0.04300 | 0.03170 | 0.0303 | 0.026 | 0.02078 | 0.01650 | 0.01230 | 0.00820 |
| 90 | 0.03106 | 0.02300 | 0.0220 | 0.019 | 0.01515 | 0.01200 | 0.00900 | 0.00600 |
| 80 | 0.02224 | 0.01653 | 0.0158 | 0.014 | 0.01092 | 0.00870 | 0.00650 | 0.00430 |
| 70 | 0.01576 | 0.01175 | 0.0113 | 0.0096 | 0.00778 | 0.00620 | 0.00460 | 0.00310 |
| 60 | 0.01104 | 0.00824 | 0.0079 | 0.0068 | 0.00547 | 0.00440 | 0.00330 | 0.00220 |
| 50 | 0.00763 | 0.00571 | 0.0055 | 0.0047 | 0.00379 | 0.00300 | 0.00230 | 0.00150 |
| 40 | 0.00519 | 0.00389 | 0.0037 | 0.0032 | 0.00259 | 0.00206 | 0.00150 | 0.00100 |
| 30 | 0.00344 | 0.00258 | 0.0025 | 0.0021 | 0.00172 | 0.00140 | 0.00100 | 0.00070 |
| 20 | 0.00214 | 0.00161 | 0.0015 | 0.0013 | 0.00107 | 0.00080 | 0.00060 | 0.00040 |
| 10 | 0.00131 | 0.00098 | .00093 | 0.0008 | 0.00065 | 0.00050 | 0.00040 | 0.00030 |
| 0 | 0.00078 | 0.00059 | .00056 | .00047 | 0.00039 | 0.00030 | 0.00020 | 0.00016 |

In this example, relative humidity may be about 40%. Air starting at about 70 degrees Fahrenheit may be able to hold about 0.0062 lb. water/lb. air, or about 0.744 lb. water/minute for the air flow described above. As described above, the product may have an initial starting temperature of between about 160° F. and about 205° F., substantially higher than ambient conditions. By employing the counterflow system 10 described above, this air may be raised to about 160° F. by only passing air through hot product, by combining that air with recirculated hot air, or by adding a substantially smaller amount of externally heated air as compared to conventional systems. This temperature increase may raise the air's water-holding capacity to about 0.0923 lb. water/lb. air, or over 11 lb. water/minute. As can be seen, this temperature increase results in increasing the air's water-holding capacity by almost about 15-fold. Moreover, the addition of this water to the air may increase the air's relative humidity and, as shown in the table, this may lead to an even greater increase in water-holding capacity for a given elevated temperature.

### EXAMPLE 7

### Effect of Air Intake on Airflow Through Various System Components

The following table illustrates how a user monitoring system 10 and process, with predetermined system component volumes and retention rates of product in each of those components, may adjust air flow through system 10 and further illustrates how those adjustments affect airflow in various components. In this example, retention times may be determined for a product flow rate of 8 tons/hour.

| | | Section | | | | |
|---|---|---|---|---|---|---|
| | System | First | Second | First | Second | |
| | Air | Drying | Drying | Cooling | Cooling | |
| | Flow | Section | Section | Section | Section | |
| | (CFM) | 20 | 30 | 40 | 50 | Total |
| Area (ft²) | | 6.86 | 9.01 | 28.27 | 12.70 | |
| (measured at | | | | | | |
| bottom of | | | | | | |
| section) | | | | | | |
| Volume (ft³) | | 6.86 | 13.69 | 103.67 | 29.38 | |
| (measured | | | | | | |
| from bottom of | | | | | | |
| section to limit | | | | | | |
| switches) | | | | | | |
| Retention Time | | 1.16 | 2.31 | 17.50 | 4.96 | 25.93 |
| (min.) | | | | | | |
| | 3200 | 466.47 | 355.36 | 113.19 | 251.97 | |
| | 2800 | 408.16 | 310.94 | 99.04 | 220.47 | |
| Air | 2600 | 379.01 | 288.73 | 91.97 | 204.72 | |
| | 2400 | 349.85 | 266.52 | 84.90 | 188.98 | |
| Speed | 2200 | 320.70 | 244.31 | 77.82 | 173.23 | |
| | 2000 | 291.55 | 222.10 | 70.75 | 157.48 | |
| (ft/min.) | 1800 | 262.39 | 199.89 | 63.67 | 141.73 | |
| | 1600 | 233.24 | 177.68 | 56.60 | 125.98 | |
| | 1400 | 204.08 | 155.47 | 49.52 | 110.24 | |
| | 1200 | 174.93 | 133.26 | 42.45 | 94.49 | |

While system 10 may be able to achieve each of the air velocities shown in the table, preferably system 10 may operate to establish air flows in about the range represented by the bolded numbers. In these ranges, air flowing over product in first and second cooling sections 40, 50 may be moving slowly enough to remove substantially more heat from product than if air flow was outside preferred ranges. In turn, system 10 would then be able to apply hotter air to product in first and second drying sections 20, 30, facilitating and enhancing drying of product. As an additional benefit, system 10 may require less energy to move air at lower velocities in the preferred ranges.

For example, a system designer may be concerned that a product in first cooling section 40 should experience an air flow of about 50 ft/min. To accomplish this goal, fan 170 may be set to draw about 1400 CFM of air through system. Similarly, a designer may want to know what will happen if the air flow is set for about 2000 CFM. In this case, e.g., product in the first drying section 20 may experience an air flow of about 290 ft/min. The user may then observe the product through window 29 to see if the product is substantially fluidized at that air flow and may further be able to adjust the air flow up or down accordingly by increasing or decreasing input air flow, recirculated air flow or heated make-up air flow.

In addition, if a user is concerned about air flow through the openings in one or more of the discharge sections 60, 70, 80, the user may adjust the air flow through all of system 10 to achieve the desired air flow rates through system, for example, as shown in the table below.

| | System | | | |
|---|---|---|---|---|
| | Air Flow | | | |
| Section | (CFM) | Top | Middle | Bottom |
| Area (ft²) | | 6.86 | 9.01 | 28.27 |
| (measured at | | | | |
| bottom of | | | | |
| section) | | | | |
| Volume (ft³) | | 6.86 | 13.69 | 103.67 |
| Retention | | 1.16 | 2.31 | 17.50 |
| Time (min.) | | | | |
| | 3200 | 466.47 | 355.36 | 113.19 |
| | 2800 | 408.16 | 310.94 | 99.04 |
| Air | 2600 | 379.01 | 288.73 | 91.97 |
| | 2400 | 349.85 | 266.52 | 84.90 |
| Speed | 2200 | 320.70 | 244.31 | 77.82 |
| | 2000 | 291.55 | 222.10 | 70.75 |
| (ft/min.) | 1800 | 262.39 | 199.89 | 63.67 |
| | 1600 | 233.24 | 177.68 | 56.60 |
| | 1400 | 204.08 | 155.47 | 49.52 |
| | 1200 | 174.93 | 133.26 | 42.45 |

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A process for drying and cooling product having a starting temperature higher than ambient air temperature and a starting moisture content higher than a final moisture content, comprising:
continuously feeding product in a first direction through a series of hopper sections including at least one drying section and at least one cooling section;
moving air through product in a second direction generally opposite said first direction; and
recirculating at least a portion of said air through said product in said at least one drying section,
wherein an air flow through said cooling section is sufficiently low enough to cause an air temperature in said cooling section to be close to a product temperature in said drying section.

2. A process for drying and cooling product according to claim 1, wherein energy is introduced into said product to cause said higher starting temperature and said process recaptures a substantial amount of said energy to dry said product.

3. A process for drying and cooling product according to claim 1, wherein said air temperature in said cooling section is higher than said product temperature in said drying section.

4. A process for drying and cooling product according to claim 1, wherein said moving step comprises moving between about 150 and about 200 CFM/minute of air per ton of said product.

5. A process for drying and cooling product according to claim 1, further comprising:
adding heated make-up air to air passing through said product in said at least one drying section to further dry said product.

6. A process for drying and cooling product according to claim 1, wherein said air moves through said at least one cooling section slowly enough to cause evaporative cooling of said product in said at least one cooling section.

7. A process for drying and cooling product according to claim 1, wherein said air is at generally ambient conditions as it enters said at least one cooling section.

8. A process for drying and cooling product according to claim 1, comprising a plurality of drying sections and a plurality of cooling sections.

9. A process for drying and cooling product having a starting temperature higher than ambient air temperature and a starting moisture content higher than a final moisture content, comprising:
loading a first set of product into a drying section;
transferring at least a portion of said first set of product into a cooling section;
passing air at ambient temperature and humidity conditions through product in said cooling section to warm said air and cool said first set of product; wherein an air flow through said cooling section is sufficiently low enough to cause an air temperature in said cooling section to be close to a product temperature in said drying section;
loading a second set of product into said drying section;
passing said warmed air through said second set of product to remove heat and moisture from said second set of product;
transferring at least a portion of said second set of product into said cooling section; and
conveying at least a portion of said product in said cooling section out of said cooling section.

10. A process for drying and cooling product according to claim 9, further comprising:
recirculating at least a portion of said warmed air through said drying section to further warm said air and cool said product.

11. A process for drying and cooling product according to claim 9, further comprising:
preloading said first set of product into an additional drying section above said drying section before loading said first set of product into said drying section;
preloading said second set of product into said cooling section before loading said second set of product into said drying section;
passing said further warmed air over said first set of product and said second set of product when each said set of product is in said additional drying section to remove additional heat and moisture from said first set of product and said second set of product.

12. A process for drying and cooling product according to claim 9 wherein said air in said additional drying section substantially fluidizes said first set of product and said second set of product while in said additional drying section.

13. A process for drying and cooling product according to claim 9, wherein product is generally continuously loaded into said additional drying section.

14. A process for drying and cooling product according to claim 9, wherein said product conveyed out of said cooling section is conveyed into an additional cooling section for additional cooling of said product.

15. A process for drying and cooling product according to claim 14, wherein said air enters said additional cooling section at generally ambient conditions.

16. A system for drying and cooling comprising:
a drying section;
a cooling section, said cooling section having at least one aperture through which ambient air flows into said cooling section;
a discharge section between said drying section and said cooling section, said discharge section permitting air flow from said cooling section to said drying section;
said drying section having an exhaust, said exhaust operatively coupled to an opening in said cooling section.

17. A system for drying and cooling according to claim 16, further comprising:
an air heater operatively coupled to said opening or to a second opening in said cooling section.

18. A system for drying and cooling according to claim 17, wherein at least one of said opening and said second opening is proximate said discharge section.

19. A system for drying and cooling according to claim 16, further comprising:
a second cooling section proximate said cooling section;
a second discharge section between said cooling section and said second cooling section, said section discharge section permitting air flow from said cooling section to said second cooling section,
wherein said second cooling section has an opening for intaking ambient air.
